(19) United States
(12) Patent Application Publication
(10) Pub. No.: US 2005/0078190 A1
(43) Pub. Date: Apr. 14, 2005

(54) System and method for associating information with captured images

(76) Inventors: Daniel M. Bloom, Loveland, CO (US); Amy E. Battles, Windsor, CO (US)

Correspondence Address: HEWLETT-PACKARD COMPANY;Intellectual Property Administration, P.O. Box 272400, Fort Collins, CO, 80527-2400, US

(21) Appl. No.: 10/278,346

(22) Filed: Oct. 23, 2002

(51) Int. Cl. H04N 5/225

(52) U.S. Cl. 348/207.99; 348/209.99

(57) ABSTRACT

One embodiment of a note association system provides a system and method for associating objects and graphical information with an image capture device or a processing device.

### BACKGROUND

Digitally based image capturing devices capture images of objects. The captured image or “photograph” of an object is stored in a digital data format in the memory within, or coupled to, the image capturing device. Nonlimiting examples of a digital image capturing device are a digital camera that captures still images and/or video images, a facsimile machine (FAX) and a copy machine.

It may be desirable to attach or otherwise associate information, such as textual notes and/or captions with a captured image. For example, but not limited to, such textual information may be used to indicate the circumstances of the image (such as location, activities, personal comments, date and/or object names), may be used to identify images of a large group of images, or may be used to track other information of interest (film type, exposure and/or photographer). Thus, the textual information memorializes the image.

However, creating textual information that is attached or associated with a captured image requires an input system, such as a personal computer and keyboard, to generate text. Thus, images are captured and during later processing, the text and/or caption is attached or associated with the captured image.

Some image capture devices employ cumbersome input devices which may be incorporated into the image capture device, such as a push button, toggle switch, menu system, keyboard, or other text input device wherein the user of the image capture device manually selects individual characters one at a time to generate a textual note and/or caption that is associated with the captured image.

### SUMMARY

A system and method for associating objects and graphical information with an image capture device or a processing device are described. One embodiment comprises a method including generating an object image corresponding to an object of interest, generating a note image corresponding to graphical information relating to the object of interest, and associating the object image and the note image.

Another embodiment comprises a method for associating captured images of objects with captured images of graphical information with a processing device. This method comprises receiving an object image corresponding to an object of interest, receiving a note image corresponding to graphical information relating to the object of interest, and associating the object image and the note image.

### BRIEF DESCRIPTION OF THE DRAWINGS

The components in the drawings are not necessarily to scale relative to each other. Like reference numerals designate corresponding parts throughout the several views.

FIG. 1A is a block diagram of one embodiment of a note association system associating captured note images with object images.

FIG. 1B is a block diagram of an embodiment of a note association system residing in an image capture device.

FIG. 2 is a block diagram of another embodiment of a note associating system.

FIG. 3 is a block diagram of selected components of a digital camera.

FIGS. 4A and 4B illustrate framing of a textual note residing on an optical character recognition (OCR) sheet in a digital camera.

FIG. 5 is a flowchart of a process associating at least one captured image of graphical information with a captured image of an object of interest by an embodiment of the note association system.

FIG. 6 is a flowchart of another process associating at least one captured image of an object of interest with one captured image of graphical information by an embodiment of the note association system.

FIG. 7 is a flowchart of processing graphical information of interest into a note data with an OCR system, and associating the note data with object images, implemented by an embodiment of the note association system.

FIGS. 8A-8C is a flowchart 800 of a process associating previously captured object images and previously captured note images.

### DETAILED DESCRIPTION

A system and method for associating graphical information, such as, but not limited to, text information, with at least one captured image of an object of interest are described below. An image of the graphical information is generated by capturing an image of the graphical information residing on a suitable medium.

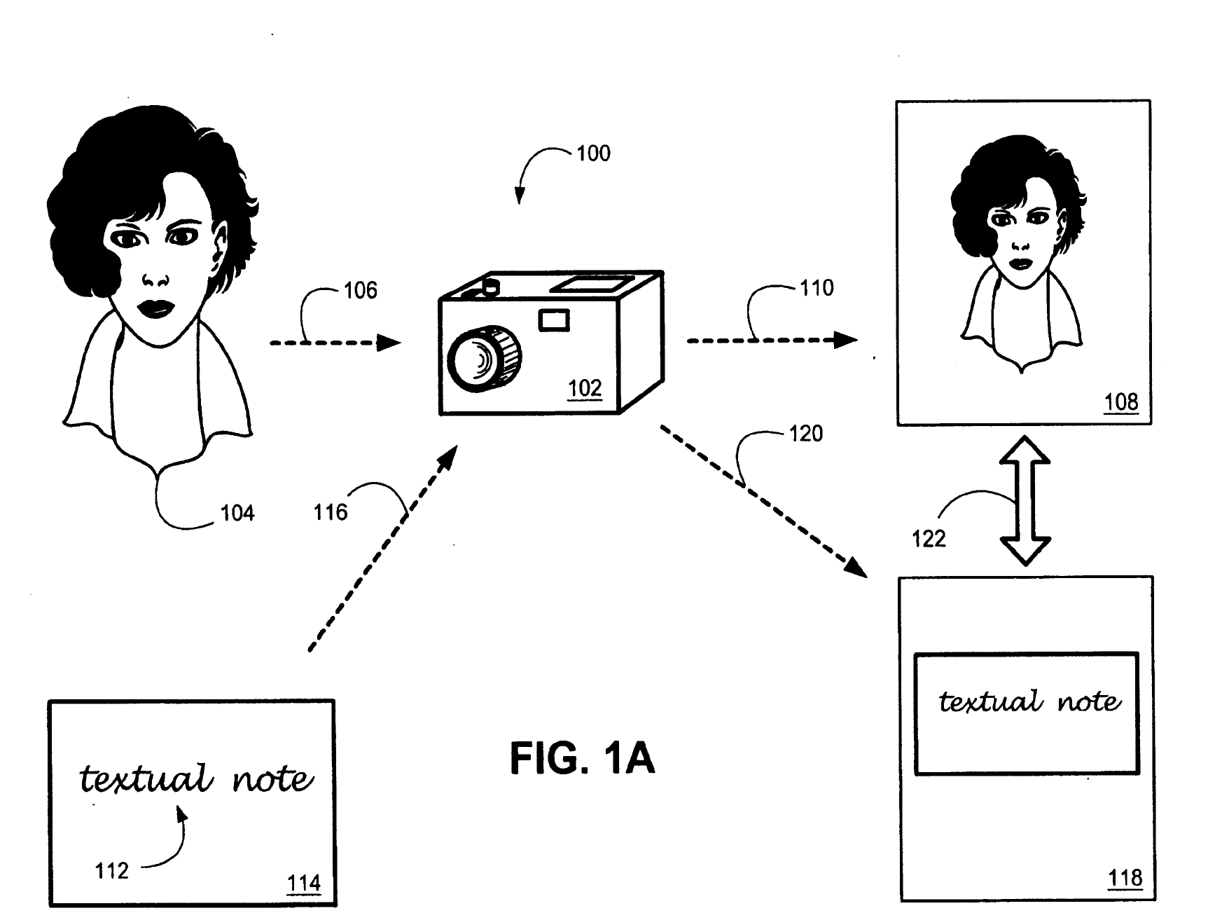

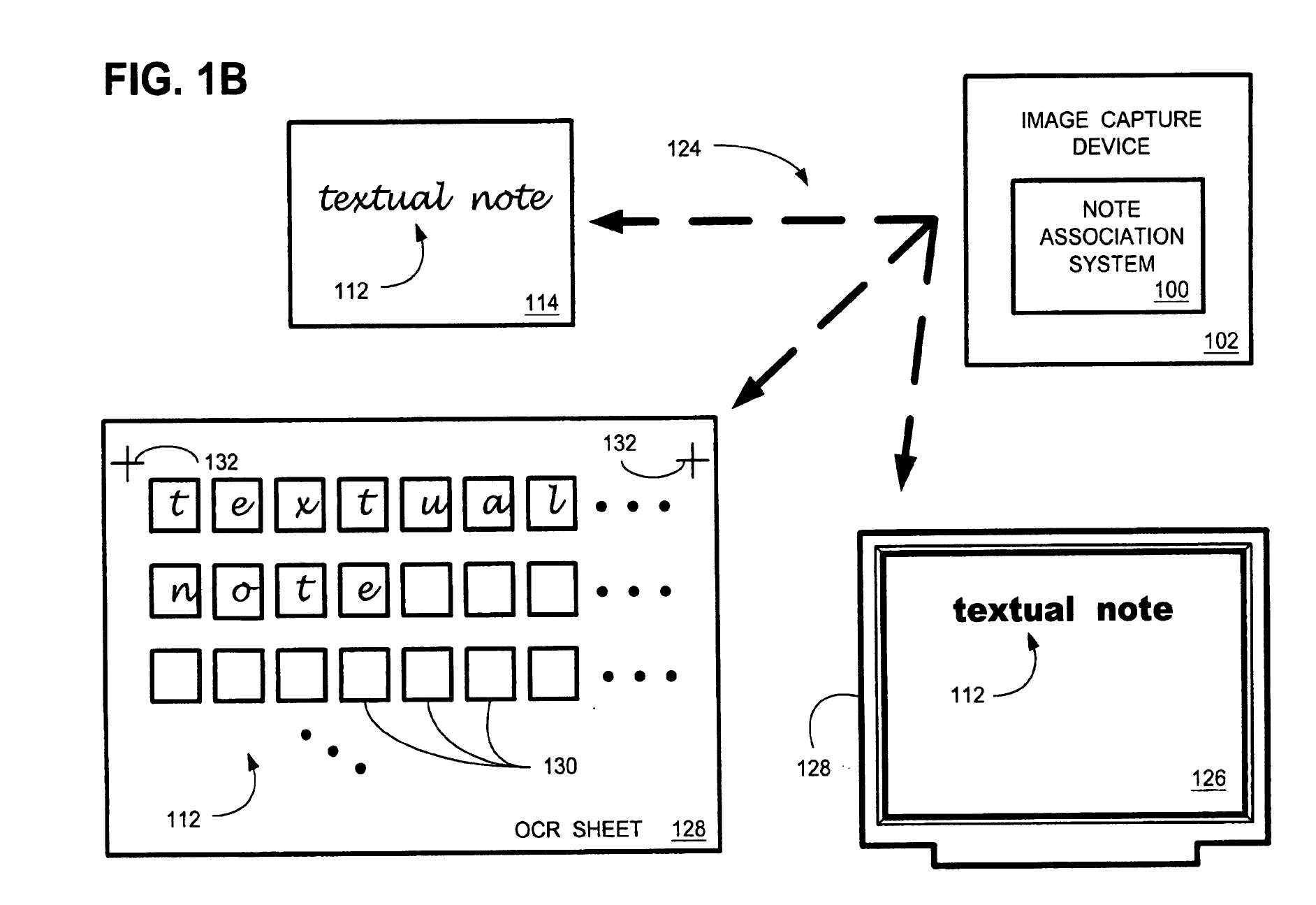

FIG. 1A is a block diagram of one embodiment of a note association system associating captured note images with object images. Note association system 100 may be implemented in a variety of image capture devices, such as, but not limited to, a digital camera, a copy machine, a facsimile machine (FAX), a scanner or another suitable image capture device. Another embodiment of a note association system 100 is a processing device configured to receive object and/or note images from a memory, and is further configured to associate (or dissociate) note images with object images. This processing device embodiment may also be configured to generate object and note images from received images.

A digital image capture device, such as digital camera 102 employing a note association system 100 embodiment, captures an image of an object of interest, illustrated as the lady 104 for convenience. Dashed-arrow line 106 indicates the capture of the image of an object of interest. Accordingly, digital camera 102 generates a captured image of the object of interest, herinafter referred to as the object image 108. As described in greater detail herein, object image 108 comprises data corresponding to light information collected by a plurality of pixels residing in a photosensor in the image capture device when exposed to the object of interest. The object image 108 is saved in a memory coupled to or residing within the digital camera 102. Generation of the object image 108 is indicated by the dashed arrow line 110.

The object image 108 is an image of an object of interest that has been captured using a digital image capture device. Examples of such objects of interest include, but are not limited to, family members (when a family portrait is captured), mountains (when a scenic landscape is captured), animals (when nature scenes are captured) or athletes (when action scenes are captured). Thus, any object that has been captured by an image capture device 102 may be associated with graphical information of interest as described herein.

In one embodiment, after the object image 108 has been generated, an image of the graphical information of interest is captured and associated with the object image 108. For convenience, the graphical information of interest is illustrated as a handwritten “textual note” 112 residing on a piece of paper 114. Typically, the graphical information of interest is relevant to the subject matter of the object of interest. As described in greater detail below, a variety of forms of graphical information of interest may be captured and processed by embodiments of the note association system 100. Dashed-arrow line 116 indicates the capture of the graphical information of interest. Accordingly, digital camera 102 generates a captured image of the graphical information of interest, herinafter referred to as the note image 118. As described in greater detail below, the note image 118 is saved in a memory coupled to or residing within the digital camera 102. Generation of the note image 118 is indicated by the dashed arrow line 120. Note image 118 comprises data corresponding to light information collected by a plurality of pixels residing in a photosensor in the image capture device when exposed to the graphical information of interest.

Embodiments of the note association system 100 are configured to associate at least one object image 108 with one note image 118, as indicated by the double-ended arrow 122. Thus, one note image 118 may be associated with a plurality of object images 108, one object image 108 may be associated with a plurality of note images 118, or a plurality of object images 108 may be associated with a plurality of note images 118. Furthermore, depending upon the embodiment, a note association system 100 may be configured to capture and associate an object image 108 and a note image 118 in various orders of image capture. For example, one embodiment is configured to first capture an object image 108, and associate the next captured image (presumed to be the note image 118) with the previously captured object image 108. In another embodiment, the note image 118 may be captured before capturing the object image 108. Yet another embodiment may employ a display system configured to allow a user to selectively associate note images 118 with object images 108. Another embodiment employs a selector such that a captured image is defined to be an object image 108 or a note image 118.

FIG. 1B is a block diagram of an embodiment of a note association system 100 residing in an image capture device 102. In this exemplary embodiment, the note association system 100 is configured to capture a variety of types of graphical information of interest and generate data corresponding to the image of the graphical information, referred to herein as a note image 118 (FIG. 1A). Image capture device 102 is illustrated as capturing images (by the image capture paths 124) of graphical information of interest residing on a suitable medium. As described above, one suitable medium is a sheet of paper 114. A non-limiting example of such graphical information of interest, indicated by the phrase “textual note” 112, may be a hand-written note describing subject matter related to the object of interest. A user of an embodiment of an image capture device 102 having note association system 100 captures an image of the textual note 112 residing on the piece of paper 114. Thus, the user may capture their hand-written notes, or hand-written notes prepared by others, and generate a corresponding note image 118.

Other examples of a suitable medium for graphical information of interest include, but are not limited to, specialized note pads, electronic display devices, manuscripts, books, cards, signs, plaques, or the like. For example, other acceptable forms of the textual note 112 include, but are not limited to, electronic text (electronic display devices), printed text (manuscripts, books, or the like), embossed text (cards), typed text (documents), painted text (signs), cast text (plaques) or the like. As another illustrative example, graphical information of interest as indicated by the phrase “textual note” 112 is shown on a display 126 residing in an electronic display device 128.

Another illustrative example of graphical information of interest is written on a specialized note pad, such as an optical character resolution (OCR) sheet 128. OCR sheet 128 is configured such that each character of the graphical information of interest, illustrated by the phrase “textual note” 112, is written into one of the character blocks 130, described in greater detail below.

It is appreciated that embodiments of the note association system 100 may be configured to capture note images of graphical information of interest residing on any suitable form of written, visible communication presented on a suitable medium. Accordingly, image capture device 102 captures an image of the graphical information of interest with sufficient resolution so that a viewer of the note image 118 (FIG. 1A) can determine the meaning of the graphical information of interest. Furthermore, in one embodiment, the graphical information of interest may be of any length, style or size that may be captured with sufficient resolution to be readable when viewed.

One hypothetical example of an object of interest is a family member named Jim. Consider an image of Jim captured at Jim's graduation on March 15 by the image capture device 102. The graphical information of interest may be a hand-written note on a piece of paper that might be phrased as “Jim's graduation picture on March 15.” Thus, the textual note “Jim's graduation picture on March 15” memorializing Jim's graduation is an example of graphical information of interest that relates to the subject matter of an object of interest (Jim). A note image 118 is generated by capturing an image of the graphical information of interest. The note image 118 is associated with the captured image of Jim (object image 108).

Another exemplary illustration of an embodiment configured to associate any combination of object images with any combination of note images is the documentation of a famous building. The user of image capture device 102 may capture a plurality of images of the building, such as a perspective view of the front of the building (a first object image), a close-up image of the building entry way (a second object image), and an image of a special feature of the building such as a tower (a third object image). The user may also capture an image of a plaque in front of the building describing the building (a first note image), an image from a selected portion of a tourist's brochure describing the building's history (a second note image), and a handwritten note describing the entry way and the tower (a third note image). The note association system 100 may be used by the user to associate the first object image (front of the building) with the first note image (plaque) and the second note image (brochure portion), to associate the second object image (entry way) with the second note image (brochure portion) and the third note image (handwritten note), and to associate the third object image with the second note image (brochure portion) and the third note image (handwritten note). It is appreciated that the possible combinations of object image and note image associations are limitless. Furthermore, another embodiment allows the user to define previously captured images as object images or note images, and to then associate selected object images with selected note images.

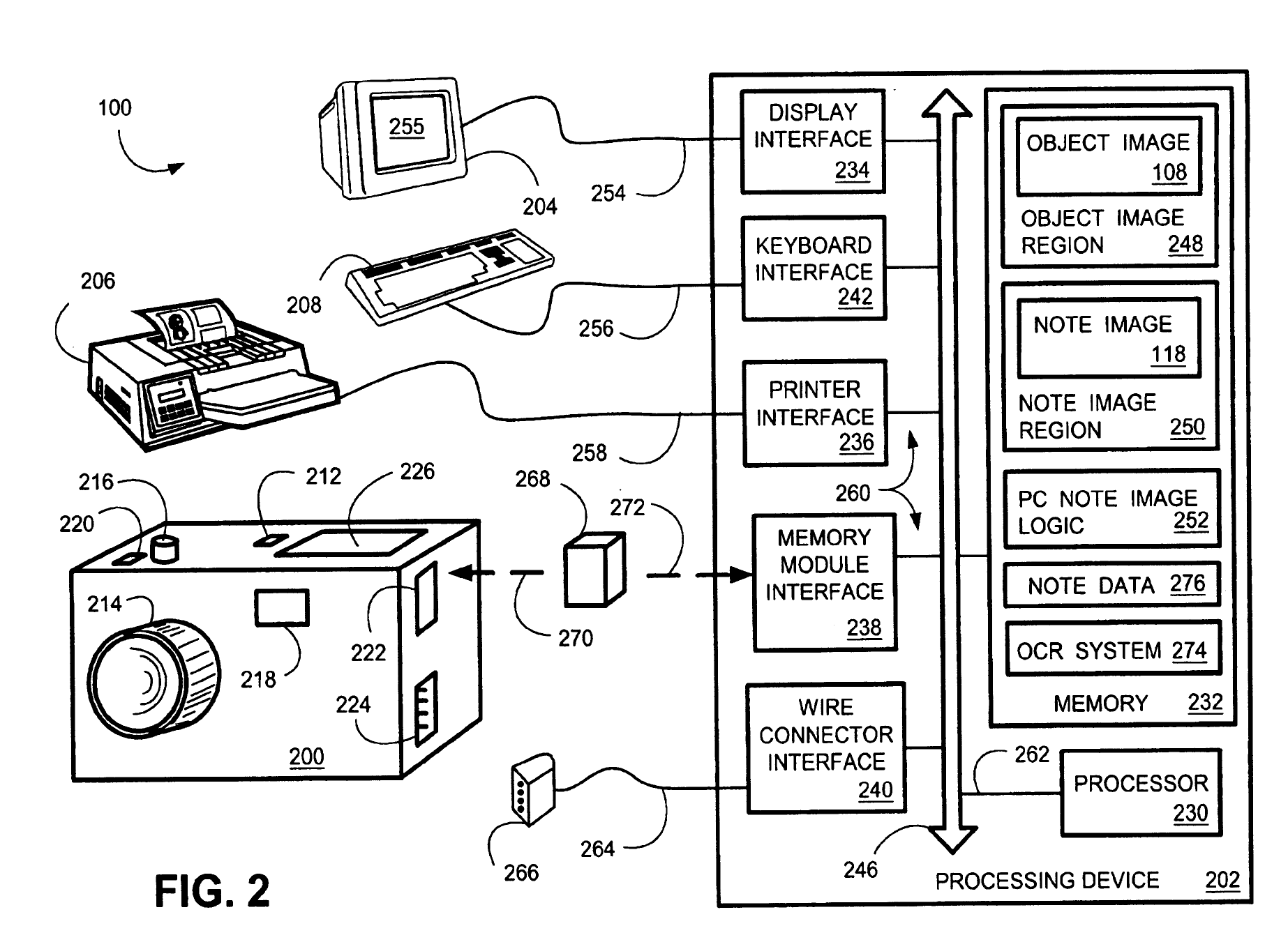

FIG. 2 is a block diagram illustrating one embodiment of a note association system 100 having at least a digital camera 200, a processing device 202, a display 204, a printing device 206, a user interface device 208. For convenience, one embodiment of the note association system 100 is described as being implemented in, or being a part of, a digital camera 200. Another embodiment of the note association system 100 may be implemented in a processing device 202. A non-limiting example of processing device 202 is a personal computer (PC). Processing device 202 is configured to retrieve previously captured object images 108 and captured note images 118 from a memory. Another embodiment is configured to generate note images and/or object images from received images generated by another device.

An exemplary embodiment of digital camera 200 includes at least a control button 212, a lens unit 214, an image capture actuation button 216, a viewing lens 218, a power switch 220, memory unit interface 222, and/or a plug-in interface 224. An optional display 226 is used for previewing images prior to capturing or for viewing captured images. For convenience of illustration, display 226 is illustrated on the top of digital camera 200.

FIG. 2 further illustrates processing device 202 configured so that digital images captured by the digital camera 200 may be retrieved, processed and/or printed by embodiments of the note association system 100. An exemplary embodiment of processing device 202 include at least a processor 230, a memory 232, a display interface 234, a printer interface 236, a memory module interface 238, a wire connector interface 240, a keyboard interface 242 and a communication bus 246. Memory 232 further includes an object image region 248 where at least one object image 108 resides, a note image region 250 where at least note image 118 resides, and personal computer (PC) note image logic 252. The object image region 248, note image region 250 and PC note image logic 252 are described in greater detail below. Memory 232 may also contain other data, logic and/or information used in the operation of processing device 202, however, such data, logic and/or information are described herein only to the extent necessary to describe the note association system 100.

Processing device 202 is illustrated as being coupled to a display 204, via connection 254, so that at least one object image and at least one note image associated in accordance with the note association system 100 can be viewed on display 255. Processing device 202 is further illustrated as being coupled to printer 206, via connection 256, so that at least one object image and at least one note image associated by the note association system 100 is printed. Also, processing device 202 is illustrated as being coupled to keyboard 208, via connection 256, so that a user can specify the association of at least one object image 108 with at least one note image 118 by embodiments of the note association system 100.

Memory 232, display interface 234, printer interface 236, memory module interface 238, wire connector interface 240 and keyboard interface 242 are coupled to communication bus 246 via connections 260. Communication bus 246 is coupled to processor 230 via connection 262, thereby providing connectivity to the above-described components. In alternative embodiments of processing device 202, the above-described components are connectivley coupled to processor 230 in a different manner than illustrated in FIG. 2. For example, one or more of the above-described components may be directly coupled to processor 230 or may be coupled to processor 230 via intermediary components (not shown).

For convenience, the user interface device 208 is hereinafter referred to as keyboard 208. Other suitable user interfaces are employed in alternative embodiments such that that a user can specify the association of object images 108 and note images 118 using embodiments of the note association system 100.

In one embodiment, digital camera 200 transfers captured object images 108 and note images 118 to processing device 202 via a hard wire connection 264. Connection 264 is coupled to a plug-in attachment 266. Plug-in attachment 266 is configured to connect to plug-in interface 224. The user simply connects plug-in attachment 266 to plug-in interface 224 thereby establishing connectivity between digital camera 200 and processing device 202. The user then instructs processing device 202 and/or digital camera 200 to transfer digital captured object images 108 and note images 118 from digital camera 200 into the object image region 248 and the note image region 250, respectively.

In another embodiment, captured object images 108 and note images 118 are stored in memory module unit 268. When capturing object images 108 and note images 118 with digital camera 200, memory module unit 268 is coupled to digital camera 200 through memory unit interface 222, as illustrated by dashed line path 270. Captured object images 108 and note images 118 are transferred to processing device 202 by removing memory module unit 268 from digital camera 200 and coupling memory module unit 268 to memory module interface 238. Typically, a convenient coupling port or interface (not shown) is provided on the surface of processing device 202 such that memory module unit 268 is directly coupled to processing device 202, as illustrated by dashed line path 272. Once memory module unit 268 is coupled to memory module interface 238, captured object images 108 and note images 1 t8 are transferred into the object image region 248 and the note image region 250, respectively.

When object images 108 and/or note images 118 are received by processing device 202, an object image 108 and a note image 108 may be selected and associated with each other, thus forming an associated object image and note image pair. Another embodiment is configured to allow multiple object images 108 and/or multiple note images 118 to be associated into groups.

Another embodiment is configured to select an associated object image and note image pair or group, and dissociate the note image from the object image. Thus, capability for later editing of object images 108 and note images 118 is provided.

Furthermore, embodiments of processing device 202 may be configured to receive images generated by other devices. Object images 108 and/or note images 108 may be defined from the received images from the other devices.

For convenience, processing device 202 is illustrated as having only selected components of interest. However, processing device 202 may include additional internal components that are not illustrated in FIG. 2. These additional components are not shown and are not described in detail herein other than to the extent necessary to understand the functionality and operation of a note association system 100.

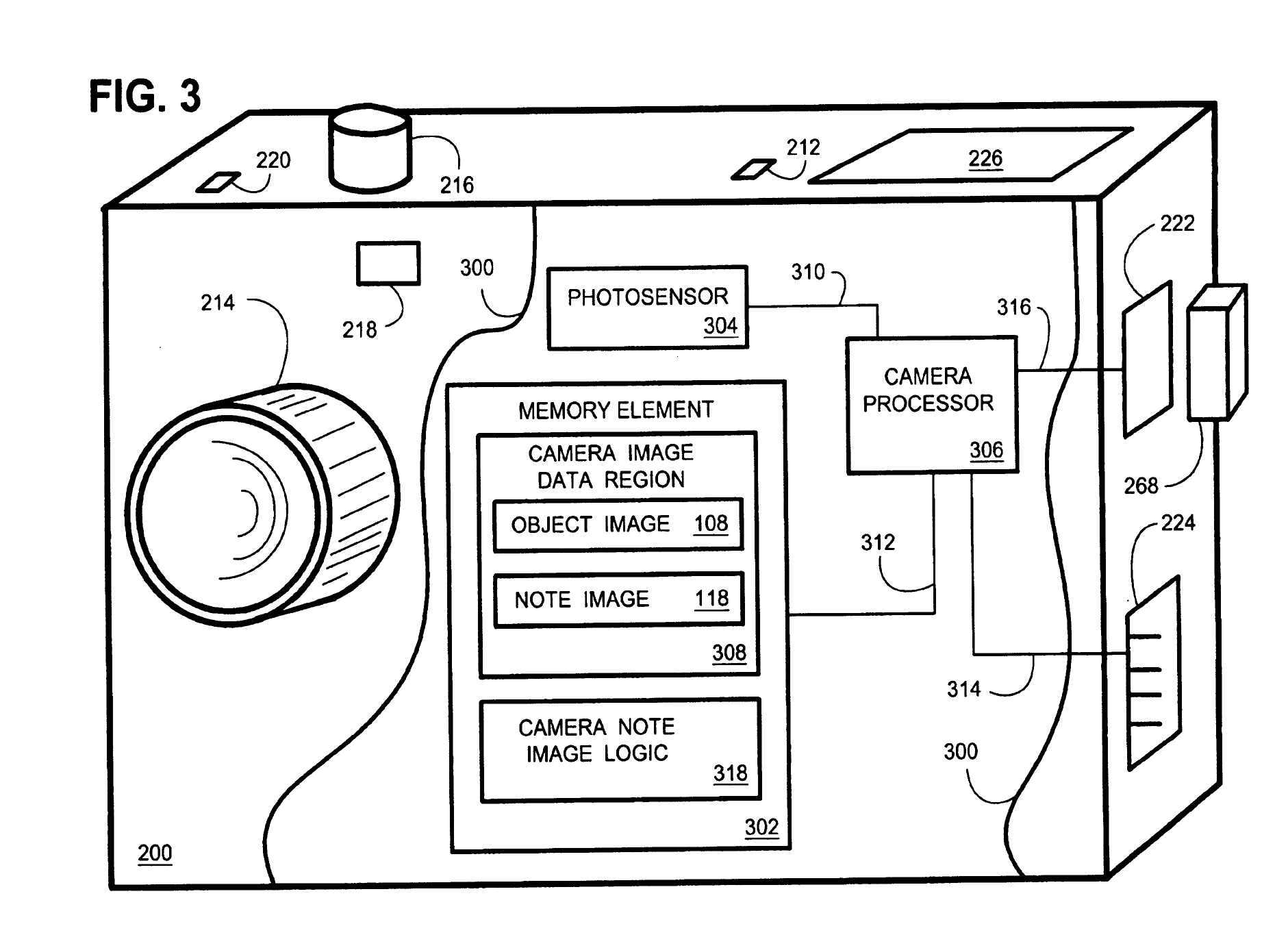

FIG. 3 is a block diagram of selected components of a digital camera 200. FIG. 2 includes selected external and internal components of the digital camera 200, demarked by cut-away lines 300. The internal components include at least memory element 302, photosensor 304 and camera processor 306. In one embodiment, memory element 302 further includes a camera image data region 308 configured to store at least one object image 108 and at least one note image 118.

Operation of the digital camera 200 is initiated by actuation of the power switch 220 or an equivalent device having the same functionality. Display 226 may display a view of an image currently visible through the lens unit 214 and detected by photosensor 304, referred to herein as a preview image. Alternatively, an image of a previously captured image (either an object image 108 or a note image 118) may be viewed on display 226. Furthermore, a menu screen may be displayed on display 226. In one embodiment, other buttons, switches or control interface devices (not shown) are additionally configured to operate display 226 such that menu items may be selected.

Prior to capturing an image of the object of interest or the graphical information of interest, the operator of the digital camera 200 may visually preview the image of the object 104 and/or the image of the textual note 112 (FIGS. 1A and 1B) on display 226. Or, the image of the object 104 and/or the textual note 112 may be viewed directly through the viewing lens 218. Photosensor 304 is disposed in a suitable location behind lens unit 214 such that an image of the object or the graphical information may be focused onto photosensor 304 for capturing. When the operator has focused the image of the object or the graphical information and is satisfied with the focused image, the operator actuates the image capture actuation button 216 (also referred to as a shutter button or a shutter release button) to cause digital camera 200 to capture the image of the object or the graphical information, thus “photographing” the object or the graphical information. A plurality of pixels (not shown) residing in photosensor 304 senses light reflected from the image of the object or the graphical information through lens unit 214. The sensed light information is collected from the pixels such that digital image data corresponding to the detected image is communicated to the camera processor 306, via connection 310.

In one embodiment, the digital image data corresponding to the captured image is communicated to the memory element 302, via connection 312. Thus, when an image of the object of interest is captured, the digital image data corresponding to the image of the object is stored in the camera image data region 308 as object image 108. Digital image data corresponding to the image of graphical information of interest is stored in the camera image data region 308 as note image 118.

Accordingly, the camera image data region 308 is configured to store many object images 108 and/or note images 118. In an embodiment employing hard wire connection 264 (FIG. 2) to communicate captured images to processing device 202, the object image 108 and/or the note image 118 is communicated from the digital camera to the hard wire connection 264 over connection 312, connection 314 and plug-in interface 224.

In another embodiment, object images 108 and/or note images 118 are transferred directly to the memory module unit 268. When capturing images with digital camera 200, memory module unit 268 is coupled to digital camera 200 through the memory unit interface 222. As the user of digital camera 200 actuates the image capture actuation button 216 to cause the digital camera 200 to capture the current image detected by photosensor 304, camera processor 306 communicates the digital image data to the memory module unit 268, via connection 316 and the memory unit interface 222. Accordingly, memory module unit 268 is configured to store many object images 108 and/or note images 118.

For convenience, digital camera 200 is described above as employing both a memory element 308 and a memory module unit 268 to store object images 108 and/or note images 118. Preferably, digital camera 200 would, in practice, employ either the memory element 308 or the memory module unit 268 to store object images 108 and/or note images 118 because employing two different and separate memory systems would be inefficient and costly. (However, it is possible some embodiments of a digital camera 200 could employ both a memory element 308 and a memory module unit 268.)

An embodiment of camera note image logic 318 is executed by camera processor 306 such that when an image is captured, the captured image is defined as an object image 108 or a note image 118. Control button 212, in one embodiment, is actuated by the user to define a captured image as an object image 108 or a note image 118. Control button 212 is any suitable actuating device configured to at least allow a user to define a captured image as an object image 108 or a note image 118. Examples of control button 212 include, but are not limited to, a push-button, a toggle-switch, a multi-position sensing device configured to sense a plurality of switch positions, a touch sensitive device or a light sensitive device. In one embodiment, the control button 212 is a multifunction controller configured to at least cause the digital camera 200 to operate in a note association mode of operation and to define captured images as object images or note images. Furthermore, the functionality of control button 212 may alternatively be implemented as a menu displayed on display 226, and configured to allow a user to define a captured image as an object image 108 or a note image 118.

In another embodiment, control button 212 is configured to place digital camera 200 in a note association mode of operation for defining and/or associating object images 108 and note images 118. For example, in one embodiment, a first captured image is the object image 108 and the next captured image is the corresponding note image 118. Accordingly, the note image 118 is associated with the just previously captured object image 108. That is, the image capture device 200 defines the first captured image as an object image 108 and the next captured image as a note image 118. Since the user of the image capture device has been taught that digital camera 200 operates as described above, the user understands that the first captured image is the object image 108 and the next captured image is an associated note image 118.

An alternative embodiment is configured to define a first captured image as a note image 118 and the next captured image as the associated object image 108. Yet another embodiment is configured to allow multiple note images 118 to be associated with an object image 108.

One such above-described embodiment is configured to remain in the note association mode of operation until instructed to return to another mode of operation. Another embodiment is configured to capture and associate only one object image 108 and only note image 118 (with an automatic return to a previous mode of operation or a predefined mode of operation). Preferably, more than one of the above-described features are incorporated into a single embodiment, thereby providing an image capture device 200 having a wide range of operating flexibility.

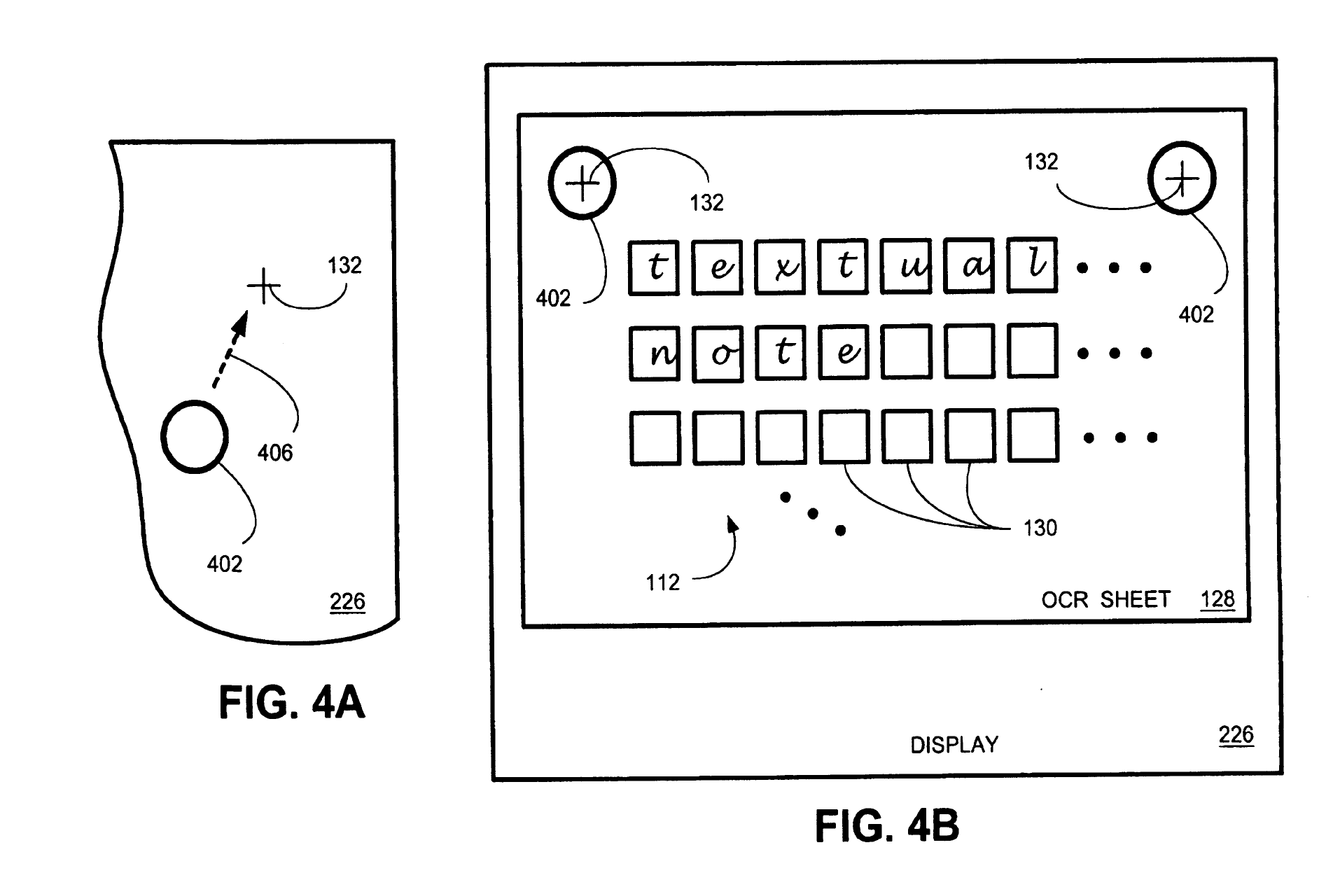

FIGS. 4A and 4B illustrate an embodiment configured to operate in conjunction with an optical character resolution (OCR) system 274 (FIG. 2). As described above, one suitable medium for graphical information is OCR sheet 128 (FIG. 1). The exemplary OCR sheet 128 includes a plurality of character blocks 130 residing in predefined locations on OCR sheet 128. A person writes a hand-written message, such as the phrase “textual note” 112, onto the OCR sheet 128 by writing one character into one character block 130.

One embodiment of an OCR sheet 128 includes at least one reference point 132 such that the user properly positions the image capture device 200 with respect to OCR sheet 128 prior to capturing an image of the phrase “textual note” 112. For convenience, two reference points 132 (see also FIG. 1B) are illustrated as an “+” on the OCR sheet 128, although any suitable form and/or number of reference points 132 may be used in other embodiments.

Initially, the user previews the OCR sheet 128 on display 226 before image capture. Or, alternatively, the user views the OCR sheet 128 through viewing lens 218 (FIGS. 2 and 3). At least one target positioning icon 402 is provided on the display 226 and/or visible through viewing lens 218. As illustrated in FIG. 4A, the target positioning icon 402 is not initially aligned with the reference point 132 when the user first points the digital camera 200 towards the OCR sheet 128. The user then moves the image capture device 200 such that the target positioning icon 402 is moved along path 406 towards the reference point 132.

FIG. 4B illustrates the acceptable positioning of the image capture device 200 such that two target positioning icons 402 are centered over the reference points 132. By providing a plurality of reference points 132 on OCR sheet 128 and a plurality of target positioning icons 402, the positioning of the image capture device 200 with respect to OCR sheet 128 is controlled with greater accuracy.

When the OCR sheet 128 is positioned such that the two target positioning icons 402 are centered over the respective reference points 132, an image the graphical information of interest (the phrase “textual note” 112) is captured so that a note image 118 is generated. The OCR system 274 (FIG. 2), integrated to operate with the camera note image logic 318 (FIG. 3), is then able to interpret the characters of phrase “textual note” 112 and generate note data 276 corresponding to the captured phrase “textual note” 112. Such note data 276 is used in one embodiment to generate captions that are associated with the object image 118. Another embodiment uses the generated note data 276 to prepare file names for object images 108 and/or note images 118. Accordingly, a file name portion is generated and incorporated into a part of the object image file name and a part of the note image file name so that the object image and note image are recognized as being associated together.

Yet another embodiment embeds the generated note data 276 as a watermark, as part of a header, or in another suitable location within the data of the object image 108 and/or note image 118. Another embodiment embeds the note data 276 into the object image 108 and/or the note image 118 as a watermark, as part of the header, or in another suitable location.

Furthermore, after capturing an image of the OCR sheet 128 having the exemplary phrase “textual note” 112 that is to be associated with an object image 108, the user may preview the OCR sheet 128 on display 226 prior to generating the note image 118 from the graphical information of the OCR sheet 128. Thus, if the image of graphical information on the OCR sheet 128 is not properly captured, as indicated by the relative positions of the target positioning icons 402 and the reference points 132, another image of the OCR sheet 128 can be captured and defined as a note image 118.

When camera note image logic 318 is implemented in software, it should be noted that camera note image logic 318 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. Object images 108 and/or note images 118 can be embodied in any computer-readable medium for use by or in connection with an instruction execution system, apparatus, or device, such as a computer-based system, processor-containing system, or other system that can retrieve the object images 108 and/or note images 118 from the computer-readable medium. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic, compact flash card, secure digital, or the like), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where camera note image logic 318 is implemented as firmware, as hardware or a combination of firmware and hardware, camera note image logic 318 can be implemented with any or a combination of the following known technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

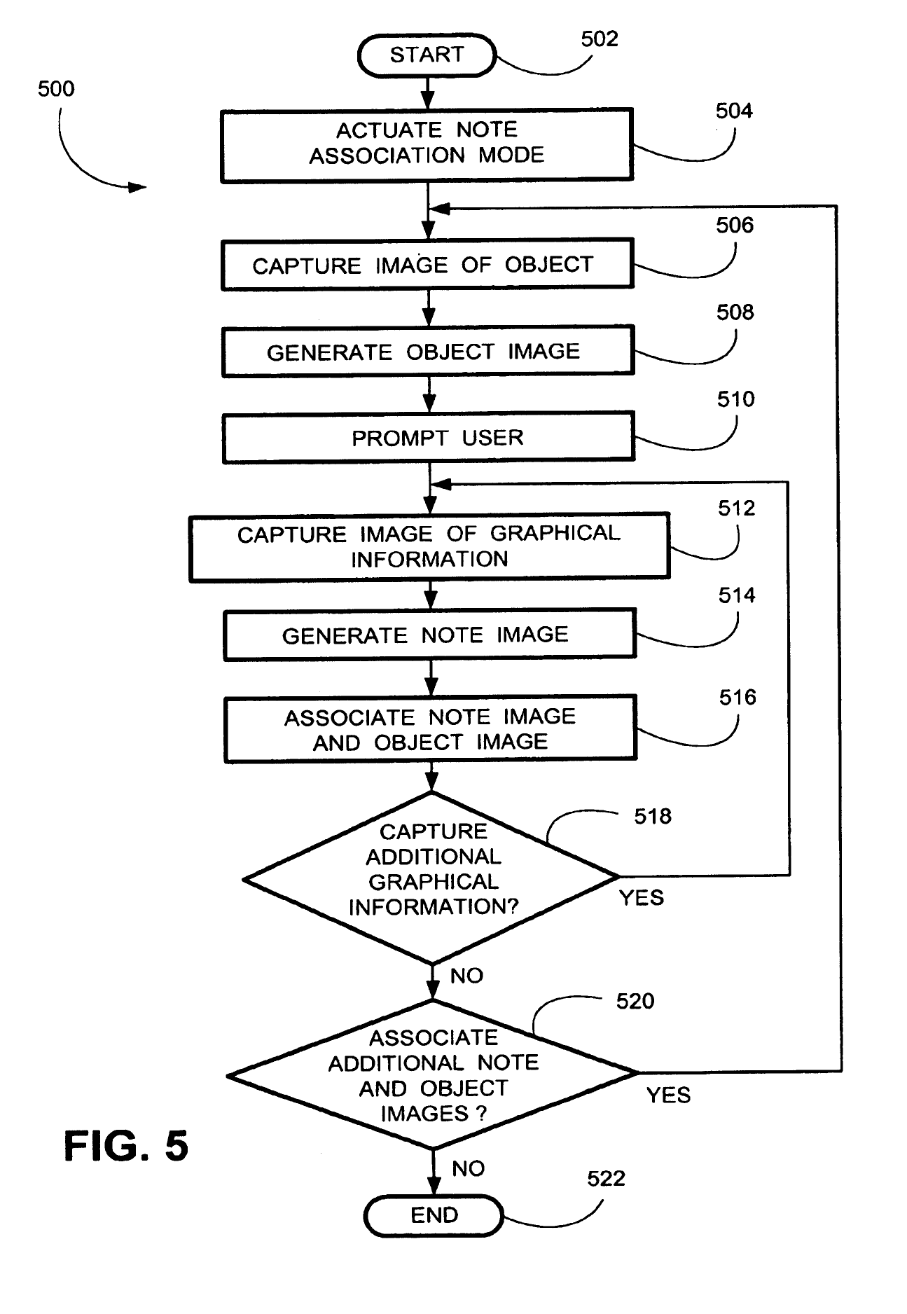

FIG. 5 is a flowchart 500 of a process associating at least one captured image of graphical information with a captured image of an object of interest by an embodiment of the note association system 100. Flowchart 500 shows the architecture, functionality, and operation of one implementation of note association system 100 configured to associate at least one note image 118 with a captured object image 108. Thus, a plurality of note images 118 may be associated with one object image 108. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved, as will be further clarified hereinbelow.

The process starts at block 502. At block 504, the image capture device 102 and/or digital camera 200 is actuated to operate in the note association mode of operation. At block 506, an image of an object of interest is captured. At block 508, the captured image of the object of interest is generated as an object image 108. (The object image 108 is then saved into a suitable memory as described herein, depending upon the embodiment of the image capture device employed to capture images.)

At block 510, the image capture device 200 prompts the user that the next captured image is to be saved as a note image 118 (an image of the graphical information of interest, such as the exemplary phrase “textual note” 112). At block 512, the image capture device 200 captures an image of the graphical information of interest. At block 514, the captured image of the graphical information is generated as a note image 118. (Similarly, the note image 118 is then saved into a suitable memory as described herein.) At block 516, the note image 118 is associated with the object image 108. Accordingly, an associated object image and note image pair is generated.

At block 518, a determination is made whether another image of graphical information is to be captured. If so (the YES condition), the process returns to block 512. Thus, additional note images 118 may be captured and associated with the current object image 310.

If capturing additional graphical information is not desired (the NO condition), the process proceeds to block 520 where a determination is made whether a new set of object images 108 and note images 118 are to be associated. If so (the YES condition), the process proceeds to block 506 such that another object image 108 is captured. If not (the NO condition), the process proceeds to block 522 and ends. The ending at block 522 may be implemented in a variety of manners, such as, but not limited to, returning the image capture device 102 and/or digital camera 200 to a previous mode of operation, returning the image capture device 102 and/or digital camera 200 to a predefined mode of operation, or shutting off the image capture device 102 and/or digital camera 200.

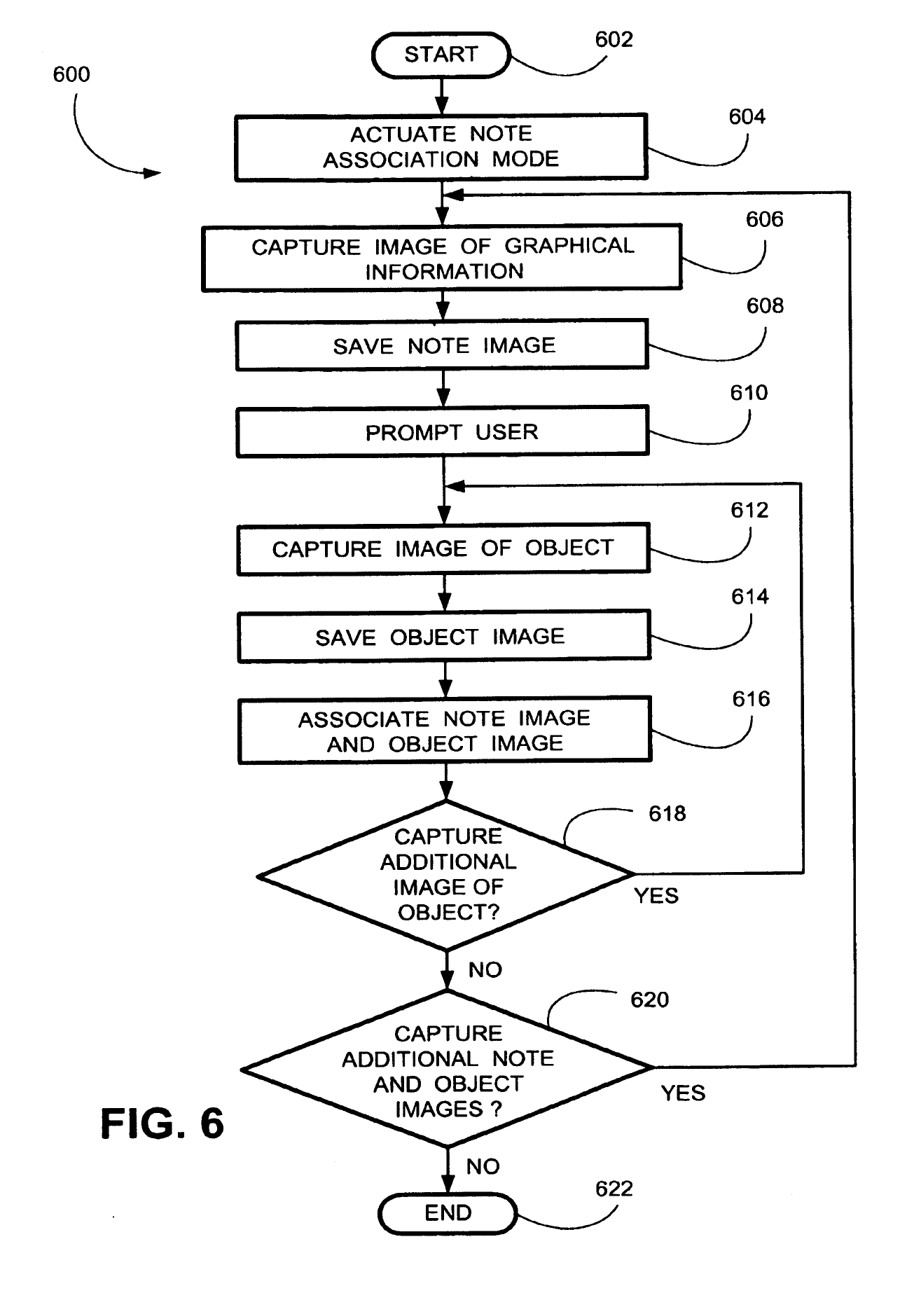

FIG. 6 is a flowchart 600 of another process associating at least one captured image of an object of interest with one captured image of graphical information by an embodiment of the note association system 100. This alternative embodiment according to flowchart 600 shows the architecture, functionality, and operation of one implementation of note association system 100 configured to associate at least one object image 108 with a captured note image 118. Thus, a plurality of object images 108 may be associated with one note image 118. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved, as will be further clarified hereinbelow.

At block 602, the process starts. At block 604, the image capture device 102 and/or digital camera 200 is actuated to operate in the note association mode of operation. At block 606, an image of the graphical information of interest, such as the exemplary phrase “textual note” 112, is captured. At block 608, a note image 118 is saved. At block 610, the image capture device 102 and/or digital camera 200 prompts the user that the next captured image is to be saved as an object image 108 (an image of an object of interest that is to be associated with the note image). At block 612, the image capture device 102 and/or digital camera 200 captures an image of an object of interest. At block 614 an object image 108 is saved. At block 616, the note image 118 is associated with the object image 108, thereby forming an associated object image and note image pair.

At block 618, a determination is made whether additional images of objects are to be captured. If so (the YES condition), the process returns to block 612. Thus, additional object images 108 are saved and associated with the current note image 118, thereby forming a group of associated object images and a note image. If additional object images 108 are not desired at block 618 (the NO condition), the process proceeds to block 620.

At block 620, a determination is made whether additional object images 108 and note images 118 are to be captured. If so (the YES condition), the process proceeds to block 606 such that another note image 118 is captured. Thus, additional object images 108 and note images 118 are associated, thereby forming a new pair or a new group of associated object images and/or note images.

If at block 620 additional object images 108 and note images 118 are not to be captured (the NO condition), the process proceeds to block 622 and ends. The ending at block 622 may be implemented in a variety of manners, such as, but not limited to, returning the image capture device 102 and/or digital camera 200 to a previous mode of operation, returning image capture device 102 and/or digital camera 200 to a predefined mode of operation, or shutting off the image capture device 102 and/or digital camera 200.

Preferably, an embodiment of an image capture device 102 and/or digital camera 200 is configured to operate in accordance with both of the flowcharts 500 and 600. Thus, additional note images 118 may be captured and associated with the current object image 108, and/or additional object images 108 may be captured and associated with the current note image 118.

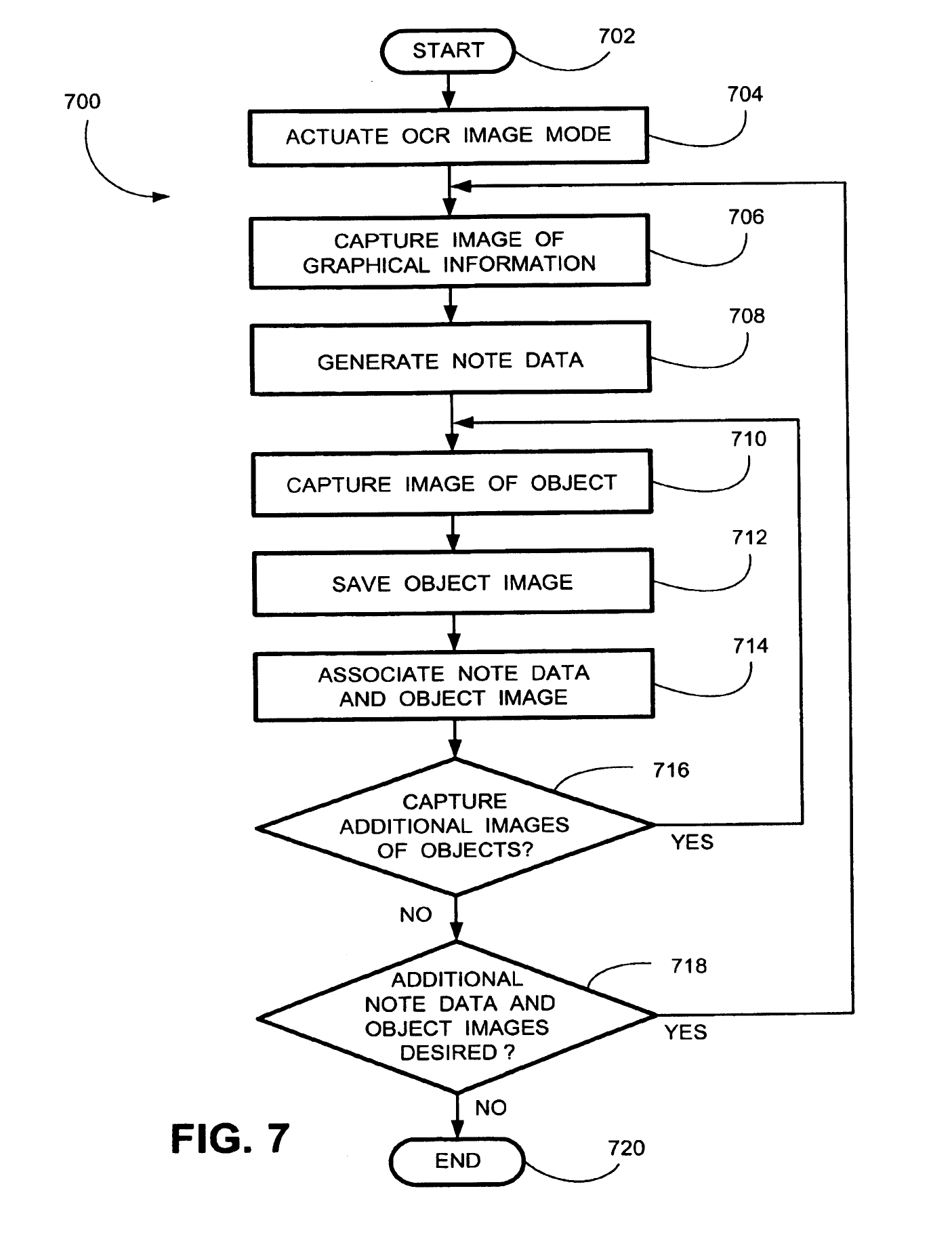

FIG. 7 is a flowchart 700 of processing graphical information of interest into a note data 276 with an OCR system 274, and associating a note data 276 with object images 108, implemented by an embodiment of the note association system 100. Flowchart 700 shows the architecture, functionality, and operation of one implementation of note association system 100 integrated with an OCR system. In this regard, each block represents a module, segment, or portion of code, which comprises one or more executable instructions for implementing the specified logical function(s). It should also be noted that in some alternative implementations, the functions noted in the blocks may occur out of the order noted in FIG. 7. For example, two blocks shown in succession in FIG. 7 may in fact be executed substantially concurrently or the blocks may sometimes be executed in the reverse order, depending upon the functionality involved, as will be further clarified hereinbelow.

The process starts at block 702. At block 704, the image capture device 102 and/or digital camera 200 is actuated to operate in the OCR image mode of operation wherein a captured image of the graphical information residing on OCR sheet 128 is captured and processed into note data 276. At block 706, an image of OCR sheet 128 is captured after the reference points 132 are properly aligned relative to the target positioning icons 402, as described above. At block 708, the OCR system generates note data 276 by converting the characters , such as text, numerals and/or symbols, of the graphical information into data. At block 710, an image of an object of interest is captured. At block 712, an object image 108 is saved. At block 714, the object image 108 is associated with the note data 276.

At block 716, a determination is made whether additional images of objects are to be captured. If so (the YES condition), the process returns to block 710 so that an image of another object is captured. Such an embodiment is desirable in associating the note data 276 with a plurality of object images. If no additional objects are to be captured (the NO condition), the process proceeds to block 718.

At block 718, a determination is made whether an additional set of note data 276 and object images 108 are desired. If so (the YES condition), the process proceeds to block 706 such that another captured image of graphical information is processed into note data 276 as described above. If not (the NO condition), the process proceeds to block 720 and ends. The ending at block 720 may be implemented in a variety of manners, such as, but not limited to, returning processing device 202 to a previous mode of operation, returning processing device 202 to a predefined mode of operation, or shutting off processing device 202.

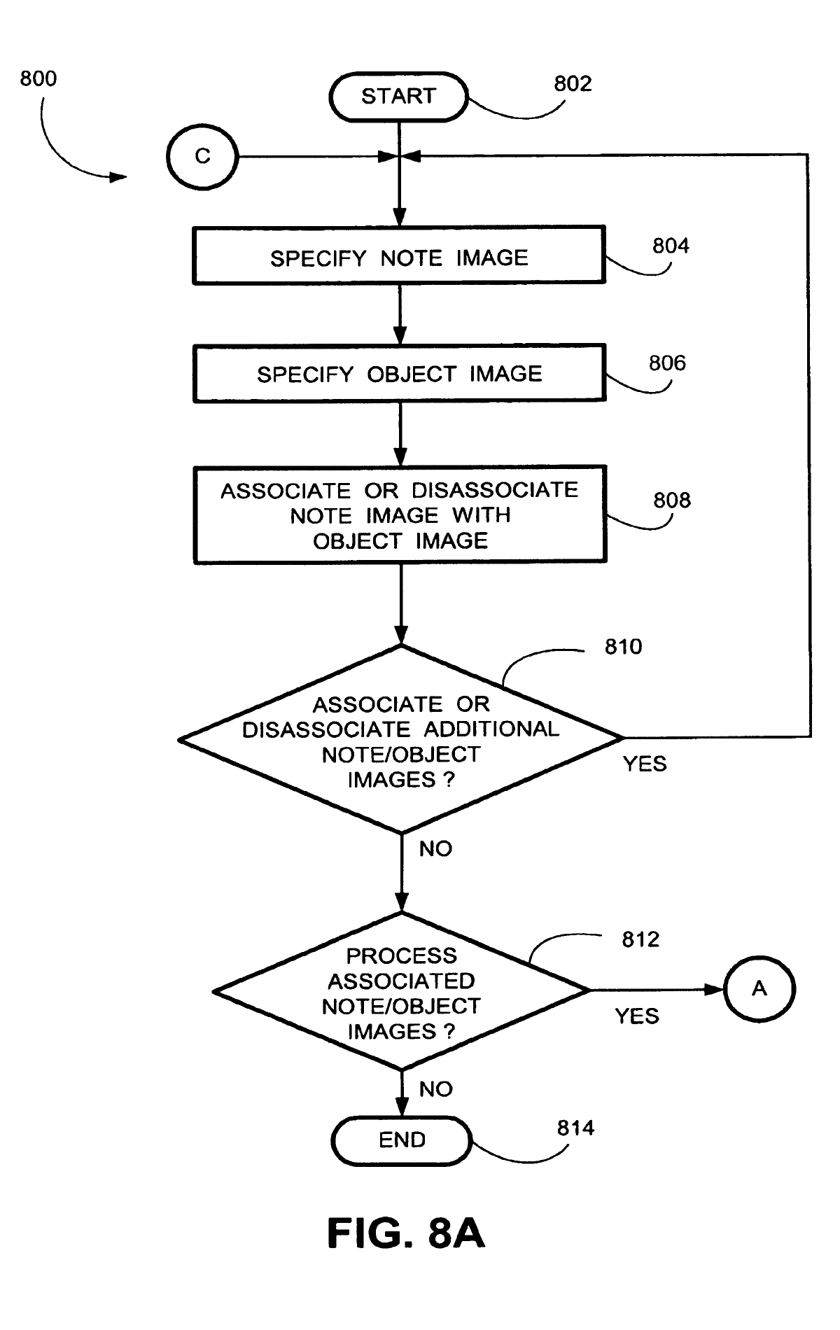

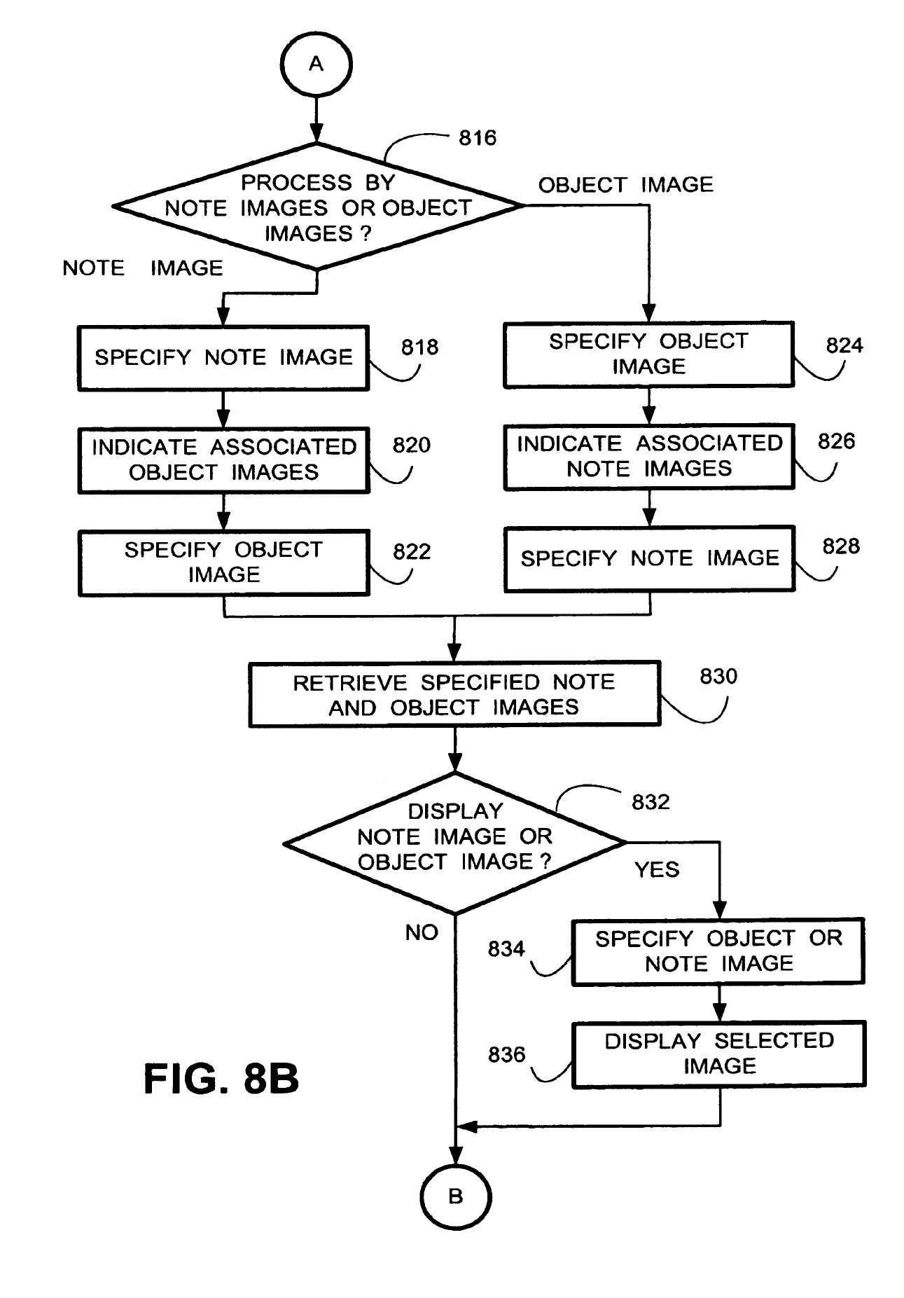

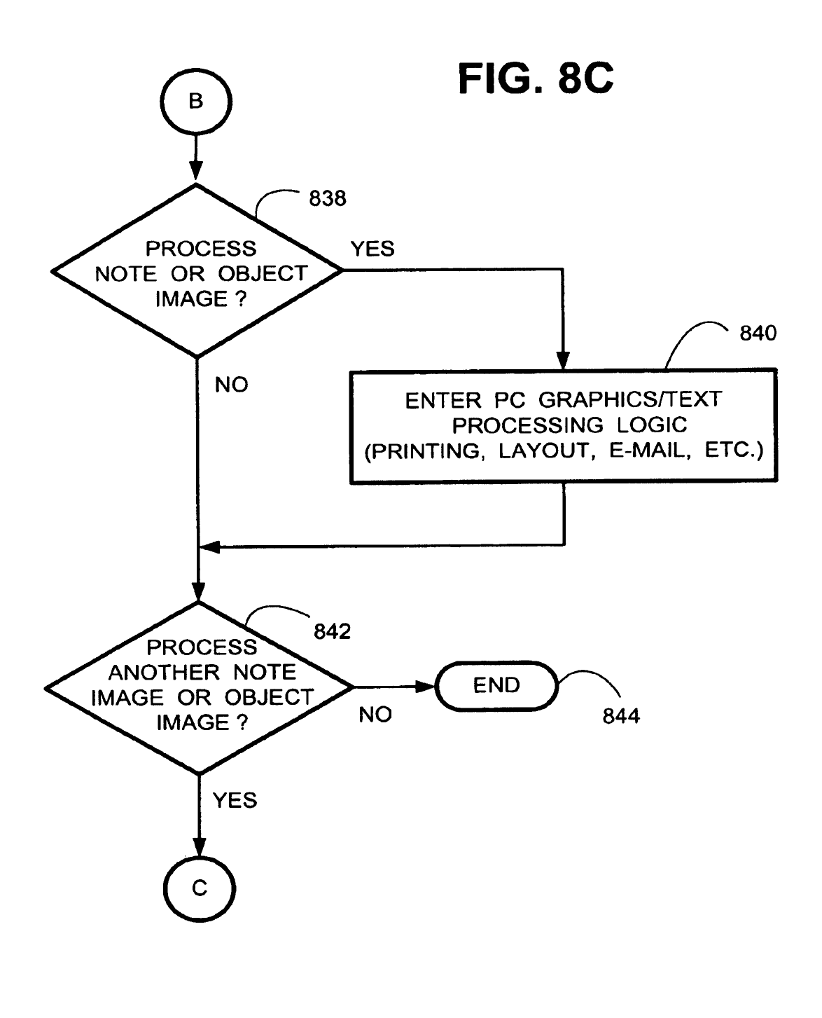

FIGS. 8A-8C is a flowchart 800 of a process associating previously captured object images 108 and previously captured note images 118 implemented in an embodiment of the processing device, such as, but not limited to, processing device 202 configured to receive captured object images 108 and note images 118 from a memory. Alternative embodiments are implemented in other suitable processing devices. In this regard, each block represents a module, segment, or portion of code, which comprises one or more executable instructions for implementing the specified logical function(s). It should also be noted that in some alternative implementations, the functions noted in the blocks may occur out of the order noted in FIGS. 8A-8C. For example, two blocks shown in succession in FIGS. 8A-8C may in fact be executed substantially concurrently or the blocks may sometimes be executed in the reverse order, depending upon the functionality involved, as will be further clarified hereinbelow.

The process starts at block 802. At block 804 a note image 118 (FIG. 1) is specified. The note image 118 may reside in a suitable location, such as, but not limited to, the note image region 250 (FIG. 2) of processing device 202, the memory module unit 268 or in the camera image data region 302 (FIG. 3) of digital camera 200. Furthermore, the note image 118 may reside in any other suitable memory media that is accessible by processing device 202, such as, but not limited to, a remote memory.

At block 806, an object image 108 is specified. At block 808, the specified note image 118 and the specified object image 108 are associated. Alternatively, at block 808, an already associated note image 118 and object image 108 may be disassociated. This embodiment is particularly advantageous for later editing of note images 118 and object images 108.

At block 810, a determination is made whether to associate (or disassociate) additional object images 118 with the specified note image 108. If so (the YES condition), the process proceeds to block 804 such that another note image 118 and object image 108 is specified. If not (the NO condition), the process proceeds to block 812.

At block 812, a determination is made whether to process the specified note images 118 and object images 108. For example, the specified note image 118 and object images 108 may be saved as a group into a memory or communicated to a printing device. If not (the NO condition), the process proceeds to block 814 and ends. The ending at block 812 may be implemented in a variety of manners, such as, but not limited to, returning processing device 202 to a previous mode of operation,

1. A method for associating images of objects and graphical information using an image capture device, the method comprising:
generating an object image corresponding to an object of interest;
generating a note image corresponding to graphical information relating to the object of interest; and
associating the object image and the note image.

2. The method of claim 1, further comprising capturing an image of the object of interest.

3. The method of claim 1, further comprising capturing an image of the graphical information with sufficient resolution such that When the note image is viewed, meaning of the graphical information is determinable by a viewer.

4. The method of claim 1, wherein generating the note image further comprises capturing an image of text, the text corresponding to the graphical information.

5. The method of claim 1, further comprising actuating a controller configured to cause the image capture device to operate in a note association mode of operation such that the object image and the note image are associated only when the image capture device is operating in the note association mode of operation.

6. The method of claim 1, further comprising:
generating a second note image corresponding to a second graphical information relating to the object of interest; and
associating the object image and the second note image.

7. The method of claim 1 further comprising:
storing the object image in a memory; and
storing the note image in the memory.

8. The method of claim 7, further comprising communicating the associated object image and the note image from the memory to a remote processing device.

9. The method of claim 1, wherein generating the note image and the object image further comprises generating with at least one selected from the group consisting of a digital camera, a facsimile (FAX) machine and a copy machine.

10. The method of claim 1, further comprising generating note data using an optical character recognition (OCR) system, the note data corresponding to characters of the graphical information.

11. The method of claim 10, comprising actuating a controller configured to cause the image capture device to operate in an OCR image mode of operation such that the note data is generated only when the image capture device is operating in the OCR image mode of operation.

12. The method of claim 10, further comprising:
generating a caption from the note data; and
associating the caption with the object image.

13. The method of claim 10, further comprising:
displaying at least one target positioning icon; and
aligning a corresponding reference point on an OCR sheet.

14. The method of claim 10, further comprising embedding the note data into the object image as a watermark.

15. The method of claim 10, further comprising embedding the note data into a header associated with the object image.

16. The method of claim 10, further comprising:
generating a file name portion corresponding to the note data; and
incorporating the file name portion into a file name of the note image.

17. The method of claim 10, further comprising:
generating a file name portion corresponding to the note data; and
incorporating the file name portion into a file name of the object image.

18. A method for associating captured images of objects with captured images of graphical information using a processing device, the method comprising:
receiving an object image corresponding to an object of interest;
receiving a note image corresponding to graphical information relating to the object of interest; and
associating the object image and the note image.

19. The method of claim 18, further comprising receiving the object image from a memory, the memory residing in a device selected from the group consisting of a digital camera, a facsimile (FAX) machine, a remote device, a copy machine and the processing device.

20. The method of claim 18, further comprising receiving the note image from a memory, the memory residing in a device selected from the group consisting of a digital camera, a facsimile (FAX) machine, a remote device, a copy machine and the processing device.

21. The method of claim 18, further comprising:
receiving a captured image of an object; and
generating the object image from the received captured image of the object.

22. The method of claim 18, further comprising:
receiving a captured image corresponding to the graphical information; and
generating the note image from the received captured image corresponding to the graphical information.

23. The method of claim 18, further comprising:
selecting an associated object image and note image pair; and
dissociating the selected note image from the selected object image.

24. The method of claim 18, further comprising:
selecting at least one of a plurality of object images;
selecting a second note image corresponding to a second graphical information; and
associating the second note image with the selected object image.

25. The method of claim 18, further comprising:
selecting at least one of a plurality of note images;
selecting a second object image; and
associating the second object image with the selected note image.

26. The method of claim 18, further comprising generating note data using an optical character resolution (OCR) system, the note data generated from the graphical information comprised of a plurality of characters.

27. The system of claim 26, further comprising generating a caption from the note data.

28. An image capture device which associates captured images of objects with captured images of graphical information, comprising:
a photosensor configured to capture images of an object of interest and at least one image of graphical information relating to the object of interest; and
a processor configured to generate an object image from the captured image of the object of interest, configured to generate a note image from the captured image of the graphical information, and further configured to associate the object image and the note image.

29. The system of claim 28, further comprising a controller configured to cause the image capture device to operate in a note association mode of operation such that the object image and the note image are associated only when the image capture device is operating in the note association mode of operation.

30. The system of claim 28, further comprising an optical character resolution (OCR) system configured to generate note data from the graphical information that comprises a plurality of characters.

31. The system of claim 30, further comprising a second controller configured to cause the OCR system to generate the note data only when the second controller is actuated.

32. The system of claim 30, wherein the processor is configured to generate a caption from the note data.

33. The system of claim 28, wherein the image capture system comprises at least one selected from the group consisting of a digital camera, a facsimile (FAX) machine and a copy machine.

34. A processing device which associates captured images of objects with captured images of graphical information, comprising:
an interface configured to receive an image of an object of interest and at least one image of graphical information from a remote memory; and
a processor configured to generate an object image from the received image of the object of interest, configured to generate a note image from the received image of graphical information, and firther configured to associate the object image and the note image.

35. The processing system of claim 34, wherein the remote memory resides in an image capture device.

36. The system of claim 34, further comprising an OCR system configured to generate note data from the graphical information that comprises a plurality of characters.

37. The system of claim 36, wherein the processor is configured to generate a caption from the note data.

38. An image capture device which associates captured images of objects with captured images of graphical information, comprising:
means for capturing images of an object of interest and at least one image of graphical information relating to the object of interest;
means for generating an object image from the captured image of the object of interest;
means for generating a note image from the captured image of the graphical information; and
means for associating the object image and the note image.
